(19) United States
(12) Patent Application Publication
(10) Pub. No.: US 2013/0201313 A1
(43) Pub. Date: Aug. 8, 2013

(54) CHILD SLEEP MONITOR

(71) Applicant: Husni Khalil, West Warwick, RI (US)

(72) Inventor: Husni Khalil, West Warwick, RI (US)

(21) Appl. No.: 13/364,657

(22) Filed: Feb. 2, 2012

(51) Int. Cl. H04N 7/18

(52) U.S. Cl. 348/77; 348/E07.085

(57) ABSTRACT

A child sleep monitor is disclosed. The device includes a base unit having a motion sensor. The base unit configured and arranged to play a pre-recorded message through the speaker when the motion sensor is activated. A camera and microphone are included in the base unit and are configured and arranged to transmit video and audio, respectively, to a monitor unit. The child sleep monitor may further include a projector that is configured and arranged to project images onto a surface for a predetermined time period.

### BACKGROUND OF THE INVENTION

1. Field of the Invention

This patent document relates generally to sleep monitors for children, especially toddlers, and more specifically to a child sleep monitor configured to direct the child to go back to bed if the child attempts to leave the bedroom.

2. Background of the Related Art

It is not always easy for a parent to get a child to go to bed, let alone staying there and then falling asleep. The child may stay up and attempt to play with toys in the bedroom or even leave the bedroom to go and find the parents. Children still need somewhere between nine and twelve hours of sleep at night. Between the ages of two and twelve, children usually start a trend toward becoming more and more sleep deprived. In other words, children that have trouble falling and staying asleep often do not get adequate sleep. As a result, the child is tired during the day. One survey of kindergarten through fourth grade age children and their teachers found that teachers reported that about 10% of the kids were falling asleep in school.

Accordingly, there is a need for a device to help parents monitor their child's sleep and help encourage the child to go to sleep and get enough rest.

### SUMMARY OF THE INVENTION

The invention solves the problems of the prior art by providing a child sleep monitor that can detect a child's movement. The device further helps parents by relieving them of the duty of to stand in front of the bedroom door to keep their child in the bedroom until the child falls asleep. The child sleep monitor is configured to play a prerecorded message form mom's or dad's to encourage the child to get back to bed when the child attempts to leave the bedroom. The child sleep monitor is further configured to play music or a story recorded (in the parent's voice) to help the child to fall asleep. The sleep monitor may further include a video camera for remote viewing of the child.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a base unit of the child sleep monitor;

FIG. 2 is a rear elevation view of the base unit of the child sleep monitor;

FIG. 3 is a bottom plan view of a mounting plate for the base unit of the child sleep monitor;

FIG. 4 is a perspective view of a remote unit of the child sleep monitor; and

FIG. 5 is an illustration of the base unit of the child sleep monitor guarding the doorway of a child's bedroom.

### DESCRIPTION OF THE PREFERRED EMBODIMENT

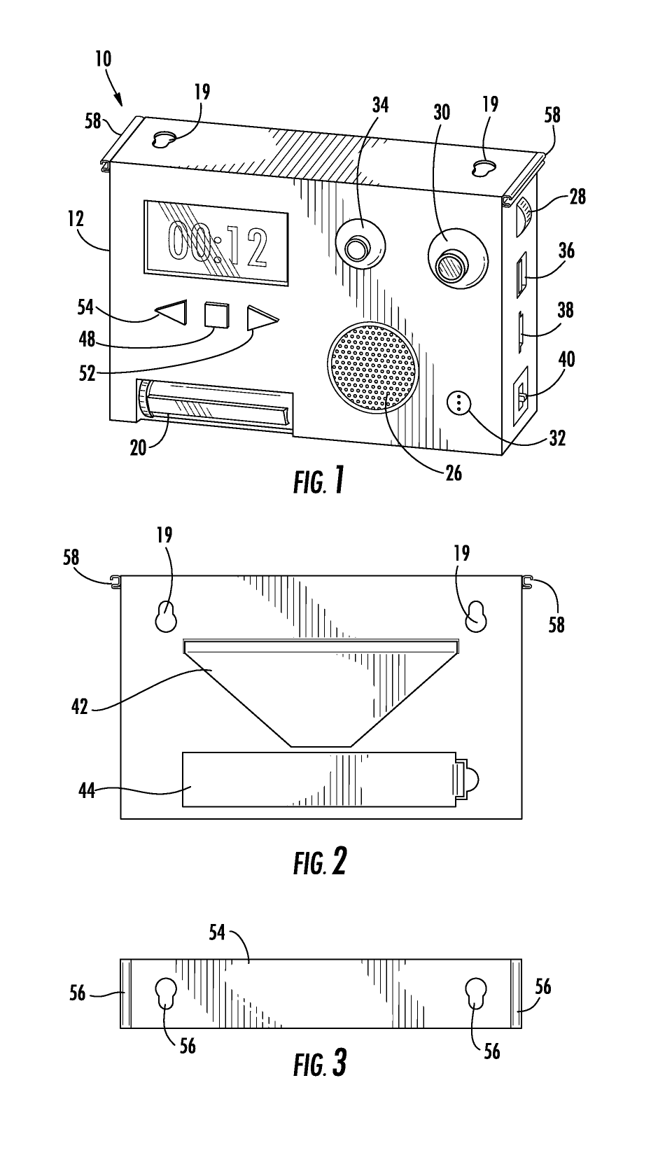

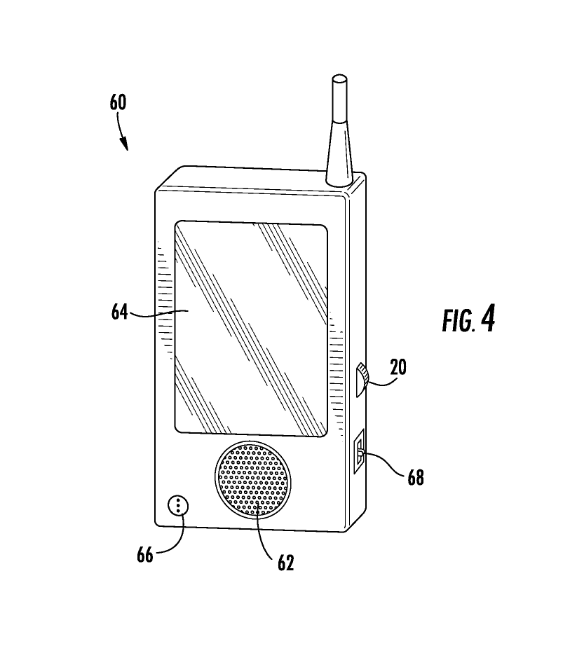

Referring to the FIGS. 1 and 2 of the drawings, a base unit 10 of the child sleep monitor is shown generally. The base unit 10 includes a housing 12 configured to be attached to a wall 14 or a doorframe (best seen in FIG. 5) and plays a message to the child 16 approaches the door 18. The housing includes various mounting holes 19 to facilitate mounting of the base unit 10.

The base unit 10 includes an adjustable motion sensor 20. As shown in FIG. 5, if a child 16 wanders into the detection range 22 of the motion sensor 20, the base unit 10 plays a pre-recorded message from an individual, such as mom or dad, to instruct the child 16 to go back to bed 24 through a speaker 26. A volume control 28 is provided to control the level of the speaker 26.

The base unit 10 includes an adjustable projector 30 that can display images, such as rotating star maps or mobiles. The projector 30 may be angled to project the images onto a nearby wall 14, the ceiling, of the floor to entertain and amuse the child 16. In addition, the base unit 10 (when the motion sensor has not been tripped) may play a second pre-recorded message to entertain the child 16, such as a story or music. The story and music may be set to play for a defined duration before terminating, described further below.

The base unit 10 includes a microphone 32 and adjustable camera 34 to permit a parent to view and hear the child 16 without risking disturbing the child 16 by entering the room. The camera 34 may be angled to a position facing the child's bed or crib.

A data port 36 is provided to permit the parent to transfer or record a message to a memory of the base unit 10. An optional memory card slot 38 may be provided to expand the memory of the base unit 10 to enable the base unit 10 to hold longer recordings of music and/or stories.

A switch 40 is provided to control the function of the base unit 10. In a first position, the motion sensor 20 may be disabled. In a second position, the camera 34 may be disabled. In a third position, the projector 30 may be disabled.

The base unit 10 may include an optional stand 42 to permit the base unit 10 to be propped on a dresser, shelf, or other flat surface. A battery compartment 44 is also provided to hold batteries to power the base unit if a wall outlet is not conveniently nearby.

The base unit 10 may also include a display 46 with a settable timer. The timer permits the parent to set a pre-determined time period to operate the projector 30 and second pre-recorded message. A function button 48 is included to enable setting of the predetermined time period. An increment button 50 is provided to increase the time and a decrement button 52 is provided to decrease the time. Pressing the function button 48 again sets the pre-determined time period.

Referring to FIG. 3, a mounting plate 54 is also provided to permit the base unit 10 to be easily attached and removed from a doorway 18 or wall 14, thereby allowing the parent to reposition the base unit 10 to another location. The mounting plate 54 includes fastener holes 56 to attach it to a surface, such as a doorway 18. The mounting plate 54 also includes mating formations 56 configured to engage reciprocal mating formations 58 on the housing 12 of the base unit 10. The mating formations 56 and reciprocal mating formations 58 engage to hold the base unit 10 to the mounting plate 54, such as by sliding onto or snapping into the mounting plate 54.

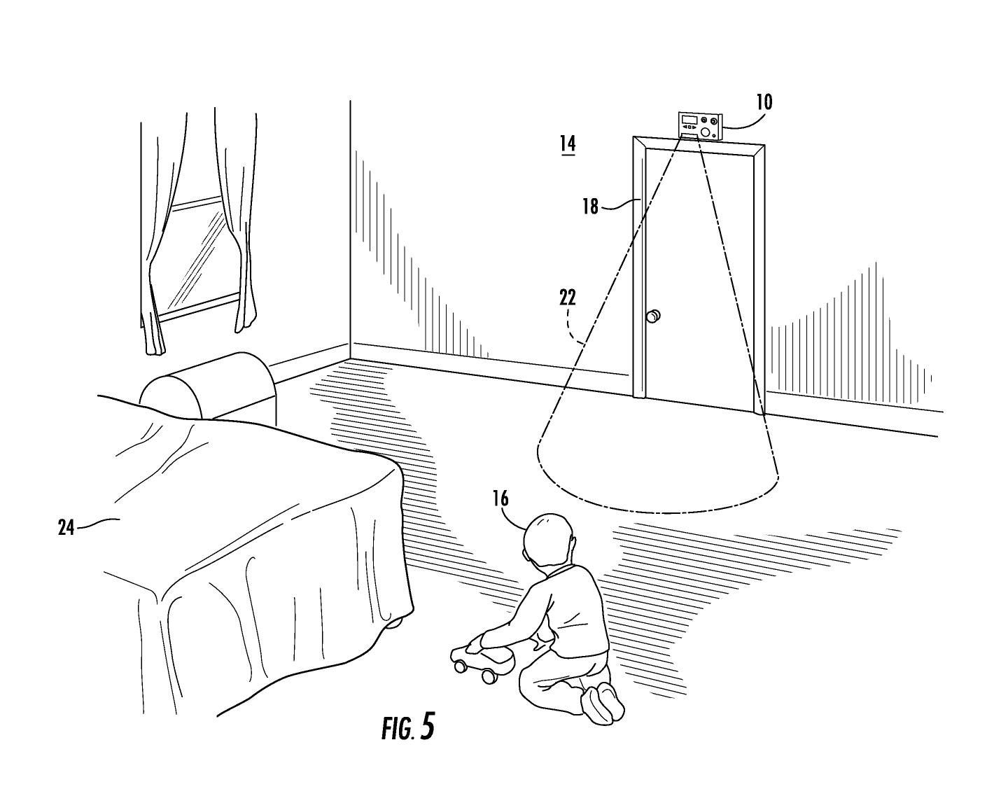

Referring to FIG. 4, the audio and video from the microphone 32 and camera 34 are transmitted wirelessly to a separate monitor unit 60. The monitor unit 60 includes a speaker 62 to listen to audio and a display 64 to view video transmitted from the microphone 32 and camera 34, respectively, of the base unit 10.

The monitor unit 60 further includes its own microphone 66 and transmitter that includes push-to-talk functionality to permit the parent to speak to the child through the base unit. Activating a push-to-talk button 68 transits audio form the monitor unit 60 to the base unit 10. The received audio at the base unit 10 is played through the speaker 26 of the base unit 10 and overrides any other audio playing or set to play through the speaker 26 of the base unit 10. Release of the push-to-talk button 66 returns control of the speaker 26 back to the base unit 10 to resume playing other audio. The monitor unit 60 may include a power switch to turn off the monitor unit 60 and a volume knob 70 to adjust the level of the speaker 62 on the monitor unit 60.

Therefore, it can be seen that the invention provides a unique solution to the problem of preventing a child from leaving the bedroom and relieving the parent of maintaining a constant guard duty of the bedroom door for toddlers that refuse to go to sleep.

It would be appreciated by those skilled in the art that various changes and modifications can be made to the illustrated embodiments without departing from the spirit of the invention. All such modifications and changes are intended to be within the scope of the present invention except as limited by the scope of the appended claims.

What is claimed is:

1. A child sleep monitor, comprising:
a base unit having a motion sensor; the base unit configured and arranged to play a pre-recorded message through the speaker when the motion sensor is activated; and
a camera and microphone configured and arranged to transmit video and audio, respectively, to a monitor unit.

2. The child sleep monitor of claim 1, further comprising a mounting plate configured and arranged to slidably receive the base unit.

3. The child sleep monitor of claim 1, further comprising a projector configured and arranged to project images onto a surface.

4. The child sleep monitor of claim 3, wherein the base unit if further configured and arranged to shut off the projector after a predetermined period of time.

5. The child sleep monitor of claim 1, wherein the monitor unit had a microphone and is configured and arranged to transmit audio from the microphone to the base unit, and the base unit is configured and arranged to play audio received from the monitor unit through the speaker.

6. The child sleep monitor of claim 1, further comprising a stand extending form the base unit.

7. The child sleep monitor of claim 1, configured and arranged to play a second pre-defined message when the motion sensor has not been activated.

8. The child sleep monitor of claim 1, further comprising a switch to disable the motion sensor.

9. The child sleep monitor of claim 1, further comprising a switch to disable the camera.

10. The child sleep monitor of claim 3, further comprising a switch to disable the projector.
